(19) United States
(12) Patent Application Publication
(10) Pub. No.: US 2025/0314676 A1
(43) Pub. Date: Oct. 9, 2025

(54) Physical Quantity Sensor And Method For Producing Physical Quantity Sensor

(71) Applicant: SEIKO EPSON CORPORATION, Tokyo (JP)

(72) Inventor: Koichiro KOMIZO, Suwa (JP)

(21) Appl. No.: 19/172,985

(22) Filed: Apr. 8, 2025

(30) Foreign Application Priority Data
Apr. 9, 2024 (JP) 2024-062711

(51) Int. Cl. G01P 1/02

(52) U.S. Cl. CPC G01P 1/023

(57) ABSTRACT

A physical quantity sensor includes a base body, a physical quantity detection element supported by the base body and configured to detect a physical quantity, and a lid body bonded to the base body via a bonding member and configured to accommodate the physical quantity detection element between the lid body and the base body. When a surface of the base body bonded to the bonding member is defined as a base body bonding surface and a surface of the lid body bonded to the bonding member is defined as a lid body bonding surface, at least one of the base body bonding surface and the lid body bonding surface is formed with a pillar structure having a recess with a bottom and a plurality of pillar portions erected at a bottom surface of the recess and disposed at an interval from each other, and the bonding member enters the recess.

The present application is based on, and claims priority from JP Application Serial Number 2024-062711, filed Apr. 9, 2024, the disclosure of which is hereby incorporated by reference herein in its entirety.

### BACKGROUND

### 1. Technical Field

The present disclosure relates to a physical quantity sensor and a method for producing the physical quantity sensor.

### 2. Related Art

A composite sensor disclosed in JP-A-2018-169365 includes a package which includes a substrate and a lid body bonded to the substrate via a bonding member and in which a first accommodation portion and a second accommodation portion are independently formed. Three acceleration sensor elements are accommodated in the first accommodation portion, and three angular velocity sensor elements are accommodated in the second accommodation portion. JP-A-2018-169365 is an example of the related art.

However, in the composite sensor described above, the bonding member that bonds the substrate and the lid body is likely to protrude inside and outside the first and second accommodation portions. Therefore, for example, the protruding bonding member may come into contact with the acceleration sensor elements or the angular velocity sensor elements and thus these elements may cease to function, or the protruding bonding member may cover a terminal and make electrical coupling to an external apparatus difficult, thereby adversely affecting surrounding members.

### SUMMARY

A physical quantity sensor according to the disclosure includes:
a base body;
a physical quantity detection element supported by the base body and configured to detect a physical quantity; and
a lid body bonded to the base body via a bonding member and configured to accommodate the physical quantity detection element between the lid body and the base body, in which
when a surface of the base body bonded to the bonding member is defined as a base body bonding surface and a surface of the lid body bonded to the bonding member is defined as a lid body bonding surface, at least one of the base body bonding surface and the lid body bonding surface is formed with a pillar structure having a recess with a bottom and a plurality of pillar portions erected at a bottom surface of the recess and disposed at an interval from each other, and the bonding member enters the recess.

A method for producing a physical quantity sensor according to the disclosure is a method for producing a physical quantity sensor including a base body supporting a physical quantity detection element that detects a physical quantity, and a lid body bonded to the base body to accommodate the physical quantity detection element between the lid body and the base body, the method including:
a pillar structure forming step of forming, on at least one of a base body bonding surface and a lid body bonding surface when a surface of the base body bonded to the lid body is defined as the base body bonding surface and a surface of the lid body bonded to the base body is defined as the lid body bonding surface, a pillar structure having a recess with a bottom and a plurality of pillar portions erected at a bottom surface of the recess and disposed at an interval from each other;
a bonding member disposing step of disposing a bonding member on at least one of the base body bonding surface and the lid body bonding surface; and
a bonding step of bonding the base body and the lid body via the bonding member.

### BRIEF DESCRIPTION OF THE DRAWINGS

FIG. 1 is a plan view showing a physical quantity sensor according to a first embodiment.

FIG. 2 is a cross-sectional view taken along a line A-A in FIG. 1.

FIG. 3 is a plan view showing a modification of the physical quantity sensor.

FIG. 4 is a cross section taken along the line A-A in FIG. 1 and is an enlarged cross-sectional view of a bonded portion between a lid body and a base body.

FIG. 5 is a cross section taken along a line B-B in FIG. 1 and is an enlarged cross-sectional view of the bonded portion between the lid body and the base body.

FIG. 6 is a cross-sectional view of a pillar structure as viewed from a plus side in a Z-axis direction.

FIG. 7 is a cross-sectional view showing a modification of the pillar structure.

FIG. 8 is a flowchart showing a step for producing the physical quantity sensor.

FIG. 9 is a cross-sectional view showing a method for producing the physical quantity sensor.

FIG. 10 is a cross-sectional view showing the method for producing the physical quantity sensor.

FIG. 11 is a cross-sectional view showing the method for producing the physical quantity sensor.

FIG. 12 is a cross-sectional view showing the method for producing the physical quantity sensor.

FIG. 13 is a cross-sectional view showing the method for producing the physical quantity sensor.

FIG. 14 is a cross-sectional view showing the method for producing the physical quantity sensor.

FIG. 15 is a cross-sectional view showing the method for producing the physical quantity sensor.

FIG. 16 is a cross-sectional view showing the method for producing the physical quantity sensor.

FIG. 17 is a cross-sectional view showing the method for producing the physical quantity sensor.

FIG. 18 is a cross-sectional view showing the method for producing the physical quantity sensor.

FIG. 19 is a cross-sectional view showing the method for producing the physical quantity sensor.

FIG. 20 is an enlarged cross-sectional view showing a bonded portion between a lid body and a base body of a physical quantity sensor according to a second embodiment.

FIG. 21 is an enlarged cross-sectional view showing a state where a bonding member disposing step is completed.

FIG. 22 is an enlarged cross-sectional view showing a modification of the pillar structure.

FIG. 23 is an enlarged cross-sectional view showing a modification of the pillar structure.

FIG. 24 is an enlarged cross-sectional view showing a modification of the pillar structure.

FIG. 25 is an enlarged cross-sectional view showing a modification of the pillar structure.

### DESCRIPTION OF EMBODIMENTS

Hereinafter, a physical quantity sensor and a method for producing the physical quantity sensor according to the disclosure will be described in detail based on embodiments shown in the accompanying drawings.

### First Embodiment

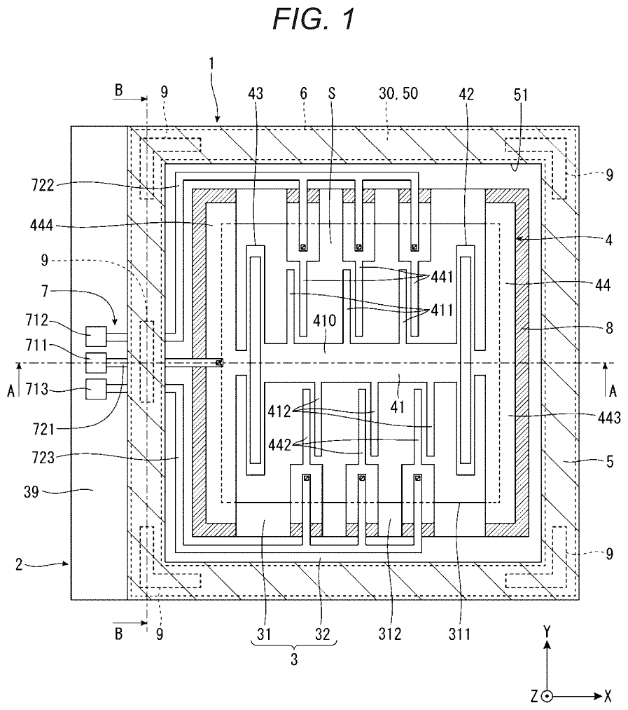

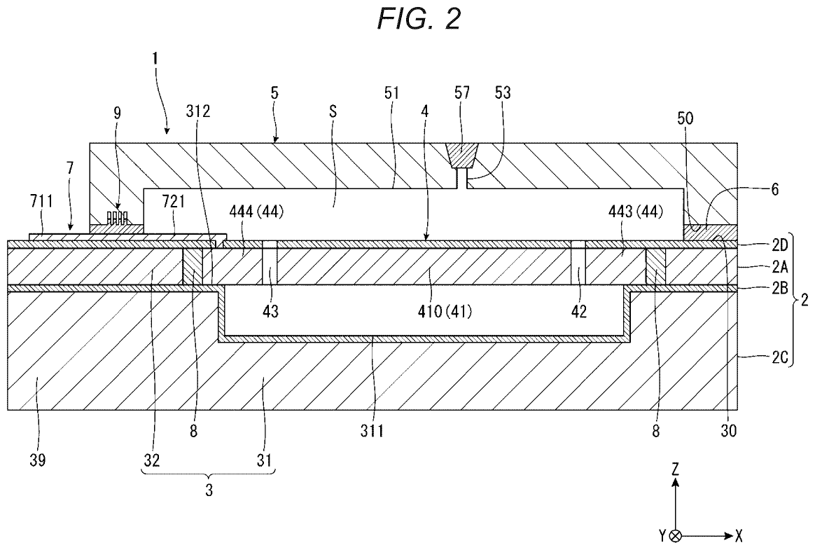

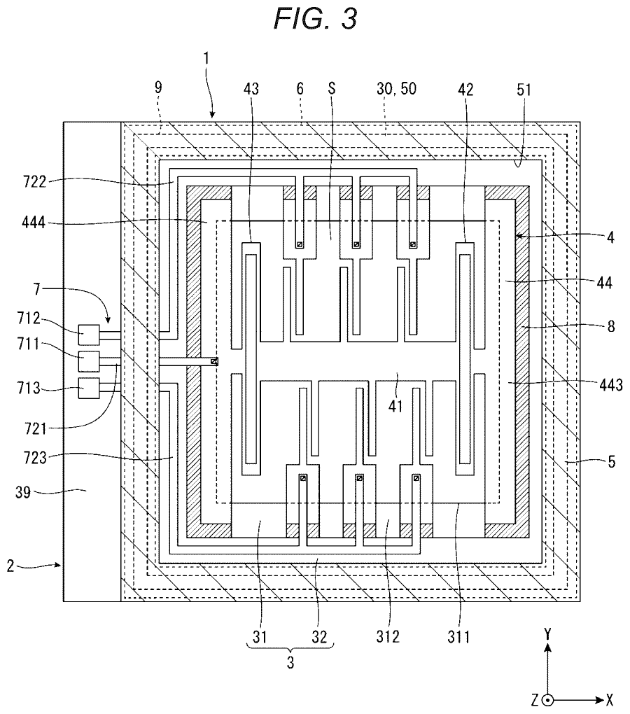

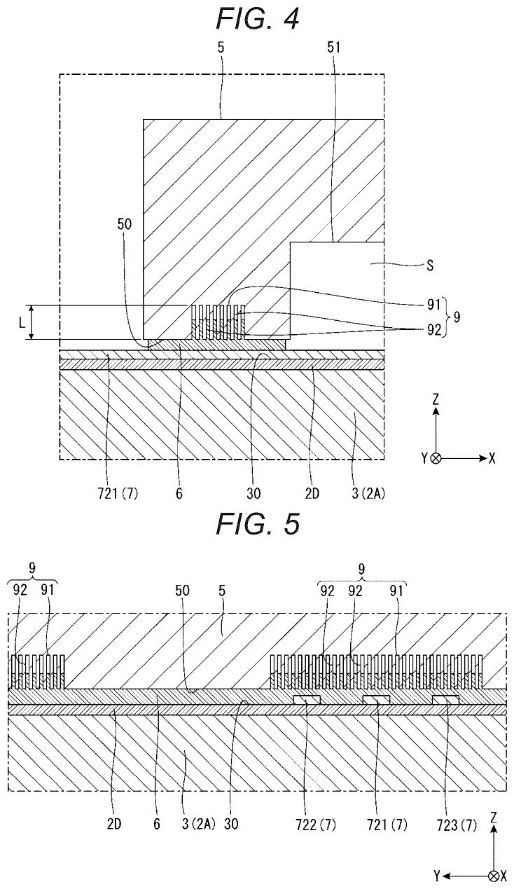

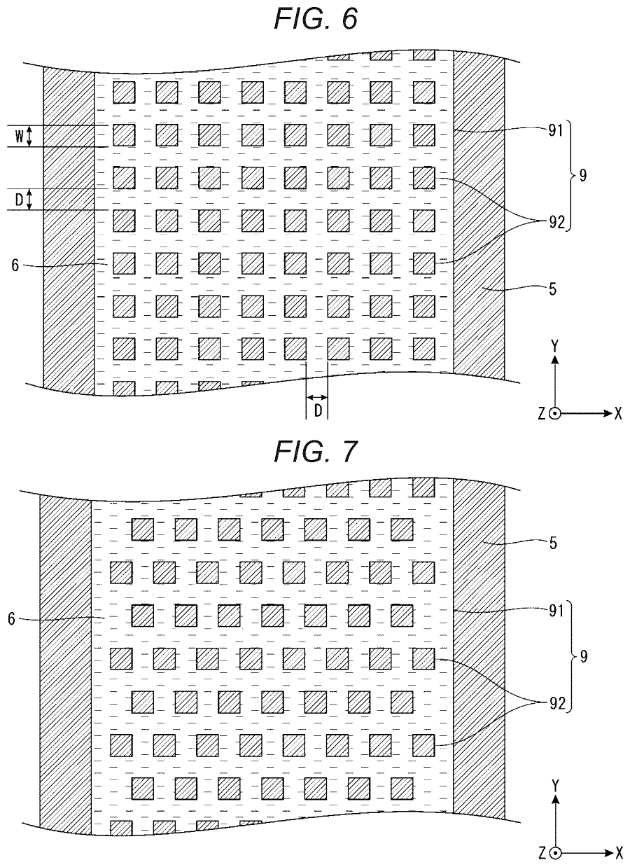

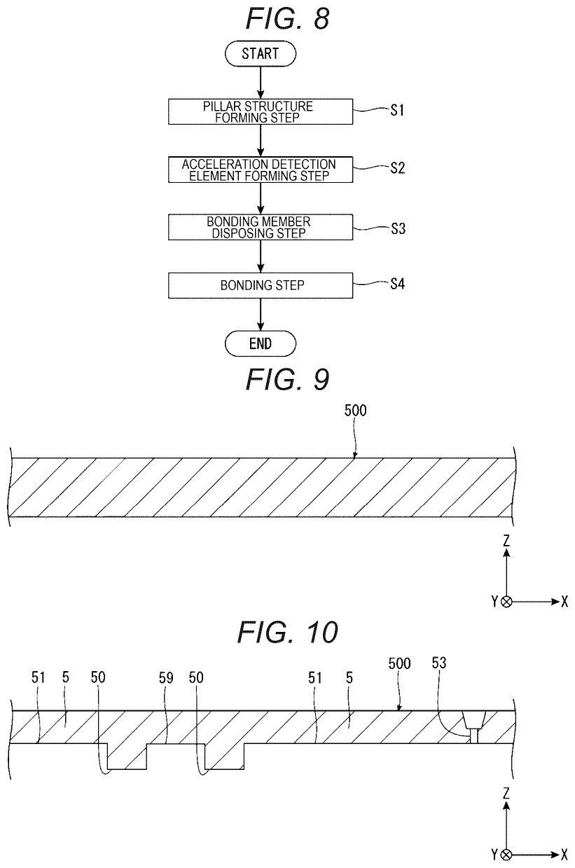

FIG. 1 is a plan view showing a physical quantity sensor according to a first embodiment. FIG. 2 is a cross-sectional view taken along a line A-A in FIG. 1. FIG. 3 is a plan view showing a modification of the physical quantity sensor. FIG. 4 is a cross section taken along the line A-A in FIG. 1 and is an enlarged cross-sectional view of a bonded portion between a lid body and a base body. FIG. 5 is a cross section taken along a line B-B in FIG. 1 and is an enlarged cross-sectional view of the bonded portion between the lid body and the base body. FIG. 6 is a cross-sectional view of a pillar structure as viewed from a plus side in a Z-axis direction. FIG. 7 is a cross-sectional view showing a modification of the pillar structure. FIG. 8 is a flowchart showing a step for producing the physical quantity sensor. FIGS. 9 to 19 are cross-sectional views showing a method for producing the physical quantity sensor.

In FIGS. 1 and 3, illustration of a second silicon oxide layer 2B is omitted for convenience of description. An X-axis, a Y-axis, and a Z-axis that are three axes orthogonal to one another are shown in drawings other than FIG. 8. Hereinafter, for convenience of description, a direction along the X-axis, that is, direction parallel to the X-axis is also referred to as an “X-axis direction”, a direction along the Y-axis is also referred to as a “Y-axis direction”, and a direction along the Z-axis is also referred to as the “Z-axis direction”. A side toward an arrowhead of each axis is also referred to as a “plus side”, and an opposite side is also referred to as a “minus side”. The plus side in the Z-axis direction is also referred to as “up,” and the minus side in the Z-axis direction is also referred to as “down”.

A physical quantity sensor 1 shown in FIGS. 1 and 2 is an acceleration sensor for detecting an acceleration in the X-axis direction. Such the physical quantity sensor 1 includes a base body 3 and an acceleration detection element 4 as a physical quantity detection element, which are integrally formed by patterning a silicon on insulator (SOI) substrate 2 through a semiconductor process, a lid body 5 bonded to the base body 3 via a bonding member 6 and forming an airtight accommodation space S that accommodates the acceleration detection element 4 between the lid body 5 and the base body 3, and a wiring group 7 routed inside and outside the accommodation space S and electrically coupled to the acceleration detection element 4.

As shown in FIG. 2, the SOI substrate 2 is a substrate having a first silicon layer 2A located on an upper side, a second silicon layer 2C located on a lower side, and the silicon oxide layer 2B interposed between the first silicon layer 2A and the second silicon layer 2C. In particular, the SOI substrate 2 in the embodiment is a cavity SOI substrate where a recess 311 is formed in advance at an upper surface of the second silicon layer 2C. Among these three layers 2A, 2B, and 2C, the first silicon layer 2A is also referred to as a device layer, the second silicon layer 2C is also referred to as a handle layer, and the silicon oxide layer 2B is also referred to as a BOX layer. A thickness of the first silicon layer 2A is approximately 200 μm or more and 300 μm or less, a thickness of the silicon oxide layer 2B is about 20 μm, and a thickness of the second silicon layer 2C is approximately 200 μm or more and 500 μm or less. However, the thickness of each of these layers 2A, 2B, and 2C is not particularly limited. An insulating layer 2D is formed at an upper surface of the SOI substrate 2. The insulating layer 2D is made of, for example, a silicon oxide, and is formed by sputtering.

### Base Body 3

As shown in FIG. 2, the base body 3 is formed of a laminate of the insulating layer 2D, the first silicon layer 2A, the silicon oxide layer 2B, and the second silicon layer 2C. Such the base body 3 includes a cavity portion 31 formed of two layers on the lower side, that is, the second silicon layer 2C and the silicon oxide layer 2B, and a frame portion 32 formed of two layers on the upper side, that is, the insulating layer 2D and the first silicon layer 2A, and disposed above the cavity portion 31.

The cavity portion 31 has the recess 311 that opens on an upper surface thereof. The recess 311 overlaps the acceleration detection element 4 in a plan view of the substrate 3, that is, in a plan view from the Z-axis direction, and functions as a relief portion that prevents contact between the base body 3 and the acceleration detection element 4. Meanwhile, the frame portion 32 surrounds an entire perimeter of the acceleration detection element 4 in the plan view from the Z-axis direction. Here, the recess 311 formed at the cavity portion 31 is smaller than an inner perimeter of the frame portion 32 in the plan view from the Z-axis direction. Therefore, the upper surface of the cavity portion 31 has an exposed portion 312 exposed to the inside of the frame portion 32. Such the exposed portion 312 of the base body 3 supports the acceleration detection element 4 from below.

The base body 3 has a protruding portion 39 protruding from the lid body 5 to the minus side in the X-axis direction and having an upper surface exposed to the outside of the accommodation space S. The wiring group 7 is led out from inside the accommodation space S onto the protruding portion 39.

Although the base body 3 has been described above, the configuration of the base body 3 is not particularly limited as long as the acceleration detection element 4 can be supported.

### Acceleration Detection Element 4

As shown in FIG. 2, the acceleration detection element 4 is formed of a laminate of the insulating layer 2D and the first silicon layer 2A. In addition, the acceleration detection element 4 is disposed inside the frame portion 32 of the base body 3 without being in contact with the frame portion 32, and is supported by the exposed portion 312 of the base body 3. As shown in FIG. 1, such the acceleration detection element 4 includes a movable portion 41 that displaces in the X-axis direction relative to the base body 3, a fixed portion 44 fixed to the exposed portion 312 of the base body 3, and a pair of spring portions 42 and 43 that couple the movable portion 41 and the fixed portion 44.

The movable portion 41 includes a base portion 410 extending in the X-axis direction, a first movable comb electrode 411 protruding from the base portion 410 to the plus side in the Y-axis direction, and a second movable comb electrode 412 protruding from the base portion 410 to the minus side in the Y-axis direction.

The fixed portion 44 includes a first fixed comb electrode 441 located on the plus side in the Y-axis direction of the movable portion 41 and interlocking with the first movable comb electrode 411, and a second fixed comb electrode 442 located on the minus side in the Y-axis direction of the movable portion 41 and interlocking with the second movable comb electrode 412. The fixed portion 44 further includes a first support portion 443 located on the plus side in the X-axis direction of the movable portion 41 and a second support portion 444 located on the minus side in the X-axis direction of the movable portion 41. An insulating separation portion 8 is provided between the fixed portion 44 and the frame portion 32, and accordingly, the base body 3 and the acceleration detection element 4 are insulated from each other. The insulating separation portion 8 is made of, for example, a silicon oxide.

Both of the spring portions 42 and 43 are elastically deformable in the X-axis direction. The spring portion 42 is located between the base portion 410 and the first support portion 443 to couple the base portion 410 and the first support portion 443. Meanwhile, the spring portion 43 is located between the base portion 410 and the second support portion 444 to couple the base portion 410 and the second support portion 444.

When an acceleration in the X-axis direction is applied to the acceleration detection element 4 having such a configuration, the movable portion 41 displaces in the X-axis direction relative to the base body 3 while elastically deforming the spring portions 42 and 43. In response to the displacement, capacitance between the first movable comb electrode 411 and the first fixed comb electrode 441 and capacitance between the second movable comb electrode 412 and the second fixed comb electrode 442 change in opposite phases. Therefore, the acceleration can be detected based on the change in the capacitance.

Although the acceleration detection element 4 has been described above, the configuration of the acceleration detection element 4 is not particularly limited as long as the acceleration can be detected.

### Wiring Group 7

As shown in FIGS. 1 and 2, the wiring group 7 is disposed at the upper surface of the SOI substrate 2, that is, an upper surface of the insulating layer 2D. In addition, the wiring group 7 includes three terminals 711, 712, and 713 disposed at an upper surface of the protruding portion 39 and exposed to the outside of the accommodation space S, and three wirings 721, 722, and 723 passing between the base body 3 and the lid body 5, routed inside and outside the accommodation space S, and electrically coupling the terminals 711, 712, and 713 and the acceleration detection element 4. The wiring 721 electrically couples the terminal 711 and the movable portion 41, the wiring 722 electrically couples the terminal 712 and the first fixed comb electrode 441, and the wiring 723 electrically couples the terminal 713 and the second fixed comb electrode 442. The three wirings 721, 722, and 723 are electrically coupled to the movable portion 41, the first fixed comb electrode 441, and the second fixed comb electrode 442, respectively, through vias penetrating the insulating layer 2D.

### Lid Body 5

As shown in FIG. 2, the lid body 5 is bonded to the base body 3 via the bonding member 6, and forms the accommodation space S for accommodating the acceleration detection element 4 between the lid body 5 and the base body 3. Such the lid body 5 is formed of a silicon substrate. However, the lid body 5 is not limited thereto and may be formed of a glass substrate, a quartz crystal substrate, or the like.

The lid body 5 is located above the base body 3 and has a recess 51 that opens downward. The recess 51 overlaps the acceleration detection element 4 in the plan view from the Z-axis direction and functions as a relief portion that prevents contact between the lid body 5 and the acceleration detection element 4. Such the lid body 5 is bonded to the upper surface of the base body 3 via the bonding member 6 at a rectangular frame-shaped lower surface around the recess 51. The bonding member 6 is, for example, glass paste. The lid body 5 also has a through hole 53 that penetrates an upper surface thereof and a bottom surface of the recess 51. The through hole 53 is used for adjusting an atmosphere in the accommodation space S at the time of producing the physical quantity sensor 1, and is then sealed with a sealing material 57.

For convenience of description, hereinafter, a surface of the lid body 5 bonded to the bonding member 6, that is, the lower surface of the lid body 5 is also referred to as a lid body bonding surface 50, and a surface of the base body 3 bonded to the bonding member 6, that is, a region of the upper surface of the base body 3 facing the lid body bonding surface 50 is also referred to as a base body bonding surface 30.

The lid body bonding surface 50, the base body bonding surface 30, and the bonding member 6 overlap each other in the plan view from the Z-axis direction and each have a rectangular frame shape. Here, as will be described in a production method to be described later, in a step of bonding the lid body 5 and the base body 3, since the lid body 5 and the base body 3 are pressed against each other, the bonding member 6 located therebetween is crushed and protrudes inside the accommodation space S or outside the accommodation space S. Then, when such protrusion of the bonding member 6 excessively occurs, various problems may occur such as (a) the bonding member 6 comes into contact with the movable portion 41 and the movable portion 41 cannot move, (b) the terminals 711, 712, and 713 are covered with the bonding member 6 and connection failure with an external apparatus occurs, and (c) a step of removing an unnecessary portion of the lid body 5 during production of the physical quantity sensor 1 does not proceed well as will be described in the production method to be described later. When such problems occur, reliability and yield of the physical quantity sensor 1 are reduced.

The protrusion of the bonding member 6 significantly occurs at a portion overlapping the wirings 721, 722, and 723. This is because this portion is crushed to be thinner than other portions by a thickness of each of the wirings 721, 722, and 723. Since the bonding member 6 has a rectangular frame shape, the protrusion of the bonding member 6 significantly occurs also at each corner portion. This is because the crushed bonding member 6 is likely to concentrate at each corner portion.

Therefore, in the physical quantity sensor 1, as shown in FIGS. 1 and 2, a pillar structure 9 is formed at the lid body bonding surface 50 in order to reduce the protrusion of the bonding member 6. As described above, the protrusion of the bonding member 6 significantly occurs at the portion overlapping the wirings 721, 722, and 723 and at each corner portion. Therefore, in the embodiment, as shown in FIG. 1, pillar structures 9 are partially formed at a total of five positions, that is, the portion overlapping the wirings 721, 722, and 723, and each corner portion at the lid body bonding surface 50. In this way, by forming the pillar structures 9 only at a part of the lid body bonding surface 50, it is possible to effectively reduce the protrusion of the bonding member 6 while minimizing a decrease in mechanical strength of the lid body 5 due to formation of the pillar structures 9. However, the disclosure is not limited thereto, and for example, as shown in FIG. 3, the pillar structure 9 may be formed in a frame shape over an entire perimeter of the lid body bonding surface 50. According to such a configuration, the mechanical strength of the lid body 5 may be lower than that in the embodiment, but the protrusion of the bonding member 6 can be effectively reduced over the entire perimeter.

Hereinafter, the pillar structures 9 will be described in detail with reference to FIGS. 4 and 5. Since the five pillar structures 9 have the same configuration, for convenience of description, FIG. 4 shows only the portion overlapping the wirings 721, 722, and 723, and FIG. 5 shows only one corner portion and the portion overlapping the wirings 721, 722, and 723.

The pillar structure 9 in the embodiment is a micro-pillar structure, and as shown in FIGS. 4 and 5, includes a bottomed recess 91 that opens at the lid body bonding surface 50, and a plurality of pillar portions 92 erected at a bottom surface of the recess 91 and disposed at an interval from each other. Each pillar portion 92 extends along the Z-axis direction. According to such a configuration, a part of the bonding member 6 crushed between the lid body bonding surface 50 and the base body bonding surface 30 is allowed to enter the recess 91, and the protrusion of the bonding member 6 can be reduced accordingly. Therefore, the above-described problems (a), (b), and (c) are less likely to occur. The bonding member 6 entering the recess 91 comes into contact with the plurality of pillar portions 92 disposed in the recess 91, thus a contact area between the bonding member 6 and the lid body 5 increases, and since the plurality of pillar portions 92 function as anchors, the bonding member 6 and the lid body 5 can be more firmly bonded. Further, the protrusion of the bonding member 6 can be reduced without increasing a size of the physical quantity sensor 1.

Such the pillar structure 9 can be formed by, for example, metal-assisted etching (noble metal catalyzed etching). The metal-assisted etching is anisotropic etching using a noble metal as a catalyst. Since only a silicon interface in contact with the noble metal such as silver nanoparticles is selectively etched, high-aspect-ratio processing is available. Therefore, the pillar structure 9 can be easily and accurately formed using the metal-assisted etching. However, the method for forming the pillar structure 9 is not particularly limited, and for example, silicon deep trench dry etching using a Bosch process or wet etching may be used.

As shown in FIG. 6, the plurality of pillar portions 92 are regularly disposed in a matrix pattern along the X-axis direction and the Y-axis direction. In this way, by regularly disposing the plurality of pillar portions 92, there is no variation in density of the pillar portions 92 in the recess 91, thus the effect of reducing the protrusion of the bonding member 6 described above and an effect of increasing bonding strength between the bonding member 6 and the lid body 5 can be uniformly obtained over an entire region of the recess 91. For example, as shown in FIG. 7, the same effects as those in the embodiment can still be obtained by regularly disposing the plurality of pillar portions 92 in a checkerboard pattern. However, the arrangement of the plurality of pillar portions 92 is not particularly limited, and for example, the arrangement may be irregular.

As shown in FIG. 6, each pillar portion 92 is a square prism. That is, the pillar portion 92 is a pillar having a square cross section. According to such a configuration, for example, a surface area of the pillar portion 92 can be larger than that of a cylinder, a triangular prism, or a pentagonal prism having the same width W. Therefore, the contact area between the bonding member 6 and the lid body 5 can be further increased, and the bonding member 6 and the lid body 5 can be more firmly bonded. The term “square prism” not only refers to a case where the cross section coincides with a square, but also includes a shape whose cross section can be regarded as being substantially the same as a square in consideration of, for example, a shape deviation or a rounded corner that may occur in production. However, the shape of each pillar portion 92 is not particularly limited, and may be a cylinder, a triangular prism, a pentagonal prism, or the like. At least one pillar portion 92 may have a shape different from that of the other pillar portions 92, for example, a square prism pillar portion 92 and a cylindrical pillar portion 92 may be mixed.

As shown in FIGS. 4 and 5, a top surface of each pillar portion 92, that is, a surface facing the base body 3 is flush with the lid body bonding surface 50. In other words, a depth L of the recess 91 is equal to a height of the pillar portion 92. With such a configuration, each pillar portion 92 and the bonding member 6 easily come into contact with each other, and the contact area between the bonding member 6 and the lid body 5 can be increased. Therefore, the bonding strength between the bonding member 6 and the lid body 5 can be further improved. However, the disclosure is not limited thereto, and the top surface of each pillar portion 92 may protrude below the lid body bonding surface 50 or may be recessed above the lid body bonding surface 50.

As shown in FIG. 4, the depth L of the recess 91 is preferably 1 μm or more and 100 μm or less. By setting the depth L to such a size, a space in the recess 91 is sufficiently large, and a sufficient amount of the bonding member 6 can enter the recess 91. Therefore, the protrusion of the bonding member 6 can be effectively reduced. In addition, it is possible to prevent the recess 91 from being deeper than necessary, and it is possible to prevent an increase in the size of the physical quantity sensor 1. It is also possible to prevent deterioration of production efficiency of the physical quantity sensor 1 due to an increase in a time required for forming the pillar structure 9. The depth L of the recess 91 is more preferably 5 μm or more and 50 μm or less, and further preferably 10 μm or more and 30 μm or less. With such a size, the above-described effects are more significant. However, the depth L of the recess 91 is not particularly limited.

As shown in FIG. 6, the width W of each pillar portion 92 is preferably 0.1 μm or more and 10 μm or less. By setting the width W to such a size, the pillar portion 92 can be sufficiently thin, and accordingly, more pillar portions 92 can be disposed in the recess 91. Therefore, the contact area between the bonding member 6 and the lid body 5 can be further increased, and more anchors can be formed. Therefore, the bonding member 6 and the lid body 5 can be more firmly bonded. The width W of each pillar portion 92 is more preferably 0.1 μm or more and 5 μm or less, and further preferably 0.1 μm or more and 1 μm or less. With such a size, the above-described effects are more significant. However, the width W of each pillar portion 92 is not particularly limited. In addition, the width W may not be uniform and pillar portions 92 having different widths W may be mixed.

As shown in FIG. 6, a separation distance D between a pair of adjacent pillar portions 92 is preferably 0.1 μm or more and 10 μm or less. In this way, by setting the separation distance D to 0.1 μm or more, a gap between the pair of adjacent pillar portions 92 is sufficiently large, and the bonding member 6 easily enters the gap. Therefore, the protrusion of the bonding member 6 can be effectively reduced. By setting the separation distance D to 10 μm or less, the gap between the pair of adjacent pillar portions 92 is not excessively large, and an appropriate number of pillar portions 92 can be formed in the recess 91. Therefore, a sufficiently large contact area between the bonding member 6 and the lid body 5 can be ensured, and a sufficient number of anchors can be formed. Therefore, the bonding member 6 and the lid body 5 can be firmly bonded. The separation distance D is more preferably 0.1 μm or more and 5 μm or less, and further preferably 0.1 μm or more and 1 μm or less. With such a size, the above-described effects are more significant. However, the separation distance D is not particularly limited.

An occupancy ratio of the pillar portion 92 to the recess 91 (a sum of volumes of the pillar portions 92/a volume of the recess 91) is preferably 10% or more and 50% or less. With such an occupancy ratio, the pillar portions 92 can be disposed in the recess 91 with appropriate density. Therefore, the bonding member 6 can easily enter the recess 91, the protrusion of the bonding member 6 can be more effectively reduced, a sufficiently large contact area can be ensured between the bonding member 6 and the lid body 5, and the bonding member 6 and the lid body 5 can be firmly bonded. The occupancy ratio is more preferably 20% or more and 40% or less, and still more preferably 25% or more and 35% or less. With such an occupancy ratio, the above-described effects are more significant. However, the occupancy ratio is not particularly limited.

The configuration of the pillar structure 9 has been described above in detail. Here, as shown in FIG. 1, each pillar structure 9 overlapping each corner portion of the bonding member 6 is bent at a right angle along the corner portion and has a portion extending in the X-axis direction and a portion extending in the Y-axis direction. With such a configuration, the pillar structure 9 has a sufficient size, and the protrusion of the bonding member 6 at each corner portion can be effectively reduced. As shown in FIGS. 1 and 5, the pillar structure 9 overlapping the wirings 721, 722, and 723 protrudes from the wirings 721, 722, and 723 in a direction orthogonal to the X-axis direction, which is an extending direction of the wirings 721, 722, and 723, that is, on both sides in the Y-axis direction in the plan view from the Z-axis direction. With such a configuration, it is possible to effectively reduce the protrusion of the bonding member 6 at the portion overlapping the wirings 721, 722, and 723.

The configuration of the physical quantity sensor 1 has been described above. Next, the method for producing the physical quantity sensor 1 will be described. As shown in FIG. 8, the method for producing the physical quantity sensor 1 includes a pillar structure forming step S1 of forming the pillar structure 9 at the lid body 5, an acceleration detection element forming step S2 of forming the acceleration detection element 4, a bonding member disposing step S3 of disposing the bonding member 6 at the lid body bonding surface 50, and a bonding step S4 of bonding the base body 3 and the lid body 5 via the bonding member 6.

### Pillar Structure Forming Step S1

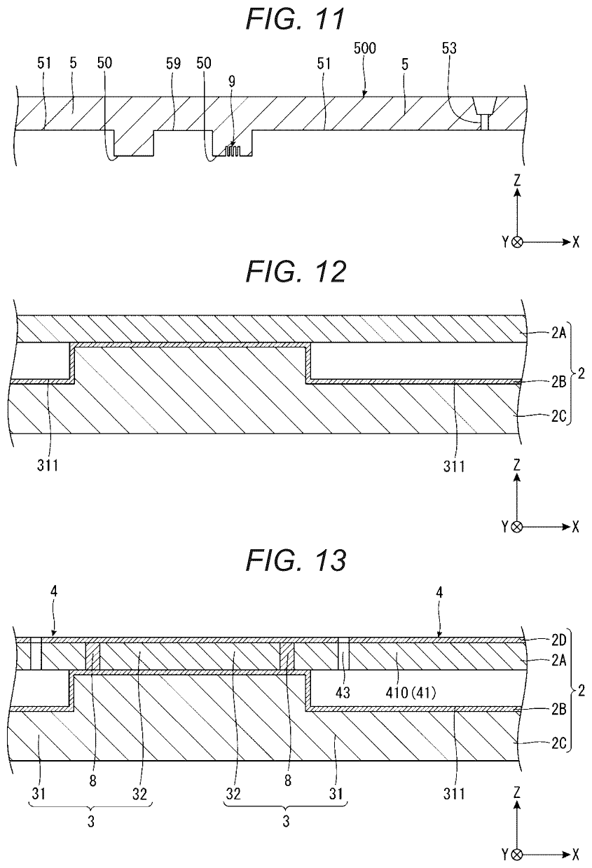

In the pillar structure forming step S1, first, as shown in FIG. 9, a silicon substrate 500 serving as a base material of the lid body 5 is prepared. A plurality of lid bodies 5 are integrally formed at the silicon substrate 500. Next, as shown in FIG. 10, a recess is formed at a lower surface of the silicon substrate 500 using, for example, dry etching. In addition to the recess 51 and the through hole 53, the recess has a recess 59 for avoiding contact between the silicon substrate 500 and the terminals 711, 712, and 713. Next, as shown in FIG. 11, the pillar structure 9 is formed at a predetermined position at the lower surface of the silicon substrate 500 using, for example, metal-assisted etching.

### Acceleration Detection Element Forming Step S2

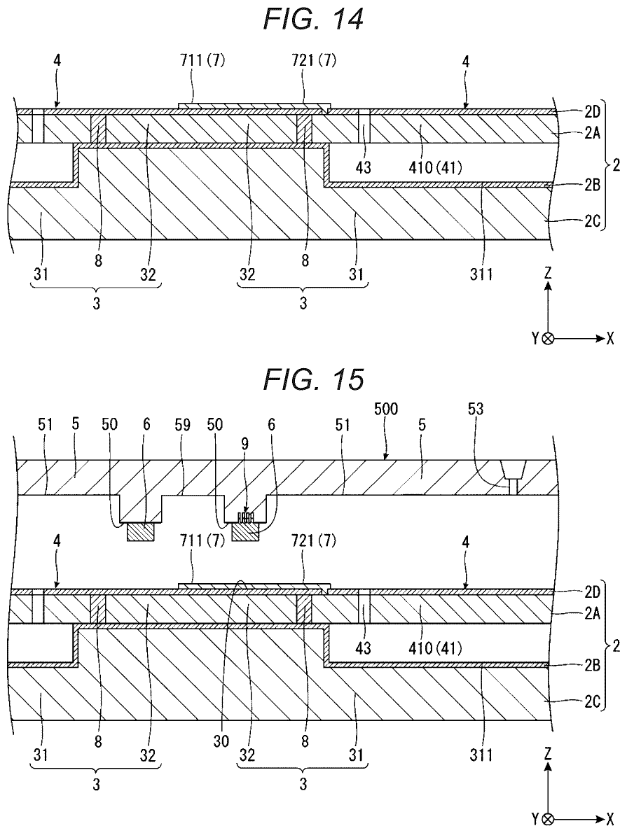

In the acceleration detection element forming step S2, first, as shown in FIG. 12, the SOI substrate 2 serving as a base material of the base body 3 and the acceleration detection element 4 is prepared. The recess 311 is formed at the SOI substrate 2 in advance. Next, as shown in FIG. 13, the acceleration detection element 4 and the frame portion 32 are formed at the first silicon layer 2A using, for example, dry etching. Next, the insulating separation portion 8 for insulating t the acceleration detection element 4 from the frame portion 32 is formed using sputtering or the like, and the insulating layer 2D is further formed on the first silicon layer 2A. As described above, the base body 3 and the acceleration detection element 4 are collectively formed from the SOI substrate 2. Next, as shown in FIG. 14, the wiring group 7 is formed at the insulating layer 2D.

### Bonding Member Disposing Step S3

In the bonding member disposing step S3, as shown in FIG. 15, the glass paste as the bonding member 6 is applied to the lid body bonding surface 50 of the lid body 5 using, for example, screen printing. The glass paste is obtained by dispersing glass frit in an organic binder. The glass paste may be applied to the base body bonding surface 30, or may be applied to both the lid body bonding surface 50 and the base body bonding surface 30.

### Bonding Step S4

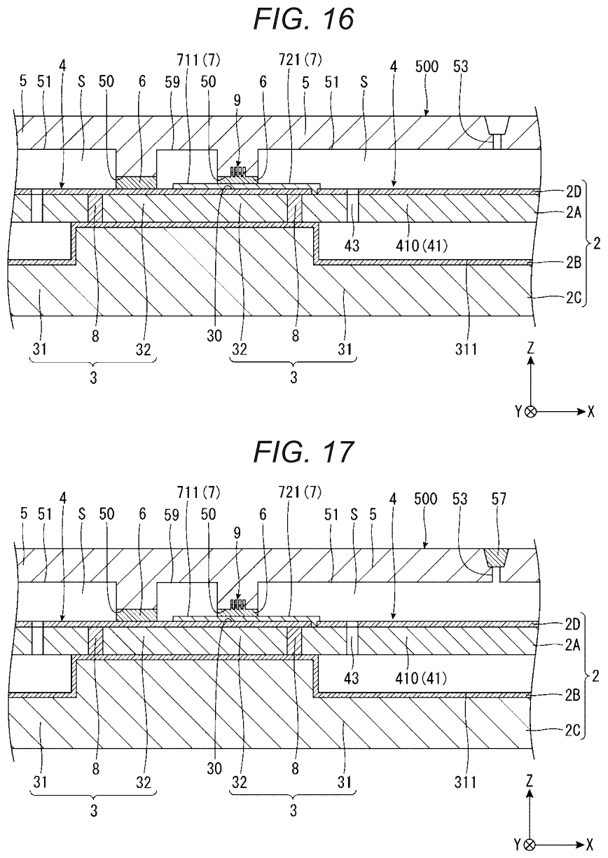

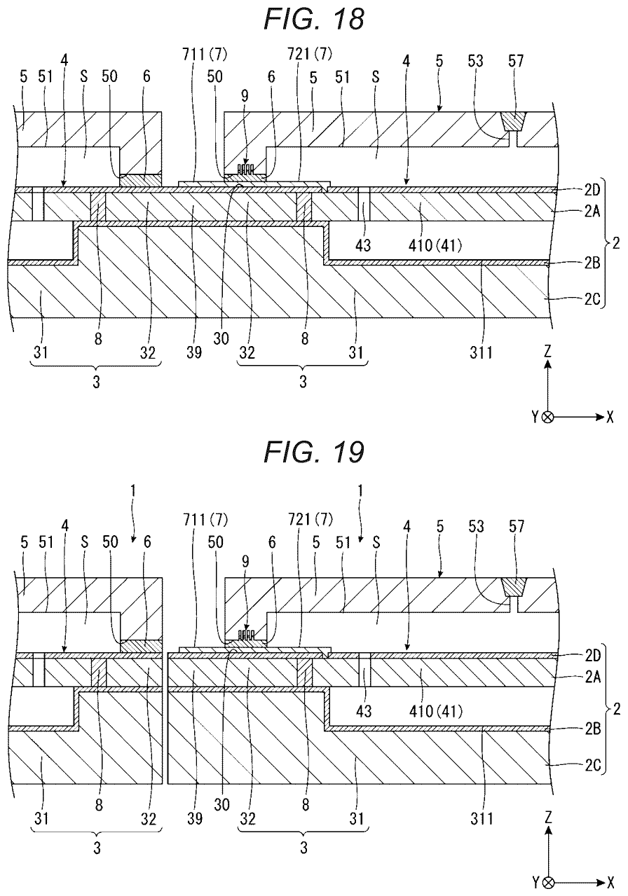

In the bonding step S4, first, as shown in FIG. 16, the lid body 5 and the base body 3 are pressed against each other and subjected to a heat treatment to bond the lid body 5 and the base body 3. Accordingly, the accommodation space S for accommodating the acceleration detection element 4 is formed. At this time, since a part of the bonding member 6 crushed between the lid body 5 and the base body 3 enters the pillar structure 9, the protrusion of the bonding member 6 inside the accommodation space S or outside the accommodation space S is effectively reduced. Next, the atmosphere in the accommodation space S is adjusted via the through hole 53, and the accommodation space S is sealed with the sealing material 57 as shown in FIG. 17. Next, as shown in FIG. 18, the lid body 5 is half-diced to remove an unnecessary portion. Accordingly, the terminals 711, 712, and 713 are exposed to the outside. When the bonding member 6 spreads along the lower surface of the lid body 5 and protrudes to the outside of the accommodation space S, a dicing saw may come into contact with the bonding member 6 at the time of half-dicing, and the unnecessary portion may not be properly removed. Finally, as shown in FIG. 19, the physical quantity sensor 1 is singulated by dicing. As described above, the physical quantity sensor 1 is produced.

According to the production method as described above, a part of the bonding member 6 crushed between the lid body 5 and the base body 3 can enter the pillar structure 9, and the protrusion of the bonding member 6 can be reduced accordingly. Therefore, the protrusion of the bonding member 6 can be reduced. The bonding member 6 entering the recess 91 comes into contact with the plurality of pillar portions 92 erected in the recess 91, thus the contact area between the bonding member 6 and the lid body 5 increases, and since the plurality of pillar portions 92 function as anchors, the bonding member 6 and the lid body 5 can be more firmly bonded.

The physical quantity sensor 1 has been described above. As described above, such the physical quantity sensor 1 includes the base body 3, the acceleration detection element 4 that is a physical quantity detection element supported by the base body 3 to detect a physical quantity, and the lid body 5 that is bonded to the base body 3 via the bonding member 6 and accommodates the acceleration detection element 4 between the lid body 5 and the base body 3. When the surface of the base body 3 bonded to the bonding member 6 is defined as the base body bonding surface 30 and the surface of the lid body 5 bonded to the bonding member 6 is defined as the lid body bonding surface 50, at least one of the base body bonding surface 30 and the lid body bonding surface 50 is formed with the pillar structure 9 having the recess 91 with the bottom and the plurality of pillar portions 92 erected at the bottom surface of the recess 91 and disposed at an interval from each other. In particular, in the embodiment, the pillar structure 9 is formed at the lid body bonding surface 50. The bonding member 6 enters the recess 91. According to such a configuration, a part of the bonding member 6 crushed between the lid body 5 and the base body 3 can enter the pillar structure 9, and the protrusion of the bonding member 6 can be reduced accordingly. Therefore, the protrusion of the bonding member 6 can be reduced. The bonding member 6 entering the recess 91 comes into contact with the plurality of pillar portions 92 erected in the recess 91, thus the contact area between the bonding member 6 and the lid body 5 increases, and since the plurality of pillar portions 92 function as anchors, the bonding member 6 and the lid body 5 can be more firmly bonded.

As described above, in the plan view of the base body 3, the bonding member 6 has a rectangular frame shape, and the pillar structure 9 overlaps the corner portion of the bonding member 6. The corner portion is a portion where the bonding member 6 is particularly likely to protrude. Therefore, according to such a configuration, the protrusion of the bonding member 6 can be more effectively reduced.

As described above, the physical quantity sensor 1 includes the wirings 721, 722, and 723 that are electrically coupled to the acceleration detection element 4 inside the lid body 5, pass between the base body 3 and the lid body 5, and are led to the outside of the lid body 5. The pillar structure 9 overlaps the wirings 721, 722, and 723 in the plan view of the base body 3. The portion overlapping the wirings 721, 722, and 723 is a portion where the bonding member 6 is particularly likely to protrude. Therefore, according to such a configuration, the protrusion of the bonding member 6 can be more effectively reduced. As described above, in the plan view of the base body 3, the pillar structure 9 protrudes on both sides of the wirings 721, 722, and 723 in the direction orthogonal to the extending direction of the wirings 721, 722, and 723. According to such a configuration, the protrusion of the bonding member 6 can be more effectively reduced.

As described above, the top surface of each pillar portion 92 is flush with the surface where the recess 91 is formed, that is, the lid body bonding surface 50 in the embodiment. According to such a configuration, each pillar portion 92 and the bonding member 6 easily come into contact with each other, and the contact area between the bonding member 6 and the lid body 5 can be increased. Therefore, the bonding strength between the bonding member 6 and the lid body 5 can be further improved.

As described above, the plurality of pillar portions 92 are regularly disposed in a matrix pattern or a checkerboard pattern. According to such a configuration, there is no variation in the density of the pillar portions 92 in the recess 91, thus the effect of reducing the protrusion of the bonding member 6 and the effect of increasing the bonding strength between the bonding member 6 and the lid body 5 can be uniformly obtained over the entire region of the recess 91.

As described above, the width W of each pillar portion 92 is 0.1 μm or more and 10 μm or less. According to such a configuration, the pillar portion 92 can be sufficiently thin, and accordingly, more pillar portions 92 can be disposed in the recess 91. Therefore, the contact area between the bonding member 6 and the lid body 5 can be further increased, and more anchors can be formed. Therefore, the bonding member 6 and the lid body 5 can be more firmly bonded.

As described above, the separation distance D between the pair of adjacent pillar portions 92 is 0.1 μm or more and 10 μm or less. According to such a configuration, the gap between the pair of adjacent pillar portions 92 is sufficiently large, and the bonding member 6 easily enters the gap. Therefore, the protrusion of the bonding member 6 can be effectively reduced. In addition, the gap between the pair of adjacent pillar portions 92 is not excessively large, and an appropriate number of pillar portions 92 can be formed in the recess 91. Therefore, a sufficiently large contact area between the bonding member 6 and the lid body 5 can be ensured, and a sufficient number of anchors can be formed. Therefore, the bonding member 6 and the lid body 5 can be firmly bonded.

As described above, the occupancy ratio of the pillar portion 92 to the recess 91 is 10% or more and 50% or less. According to such a configuration, the pillar portions 92 can be disposed in the recess 91 with appropriate density. Therefore, the bonding member 6 can easily enter the recess 91, the protrusion of the bonding member 6 can be more effectively reduced, a sufficiently large contact area can be ensured between the bonding member 6 and the lid body 5, and the bonding member 6 and the lid body 5 can be firmly bonded.

As described above, the depth L of the recess 91 is 1 μm or more and 100 μm or less. According to such a configuration, the space in the recess 91 is sufficiently large, and a sufficient amount of the bonding member 6 can enter the recess 91. Therefore, the protrusion of the bonding member 6 can be effectively reduced. In addition, it is possible to prevent the recess 91 from being deeper than necessary, and it is possible to prevent an increase in the size of the physical quantity sensor 1. It is also possible to prevent deterioration of the production efficiency of the physical quantity sensor 1 due to an increase in the time required for forming the pillar structure 9.

As described above, the method for producing the physical quantity sensor 1 is the method for producing the physical quantity sensor 1 including the base body 3 supporting the acceleration detection element 4 as the physical quantity detection element that detects the physical quantity, and the lid body 5 bonded to the base body 3 to accommodate the acceleration detection element 4 between the lid body 5 and the base body 3, the method including: the pillar structure forming step S1 of forming, on at least one of the base body bonding surface 30 and the lid body bonding surface 50 when the surface of the base body 3 bonded to the lid body 5 is defined as the base body bonding surface 30 and the surface of the lid body 5 bonded to the base body 3 is defined as the lid body bonding surface 50, the pillar structure 9 having the recess 91 with the bottom and the plurality of pillar portions 92 erected at the bottom surface of the recess 91 and disposed at an interval from each other; the bonding member disposing step S3 of disposing the bonding member 6 on at least one of the base body bonding surface 30 and the lid body bonding surface 50; and the bonding step S4 of bonding the base body 3 and the lid body 5 via the bonding member 6. According to such a production method, a part of the bonding member 6 crushed between the lid body 5 and the base body 3 can enter the pillar structure 9, and the protrusion of the bonding member 6 can be reduced accordingly. Therefore, the protrusion of the bonding member 6 can be reduced. The bonding member 6 entering the recess 91 comes into contact with the plurality of pillar portions 92 erected in the recess 91, thus the contact area between the bonding member 6 and the lid body 5 increases, and since the plurality of pillar portions 92 function as anchors, the bonding member 6 and the lid body 5 can be more firmly bonded.

### Second Embodiment

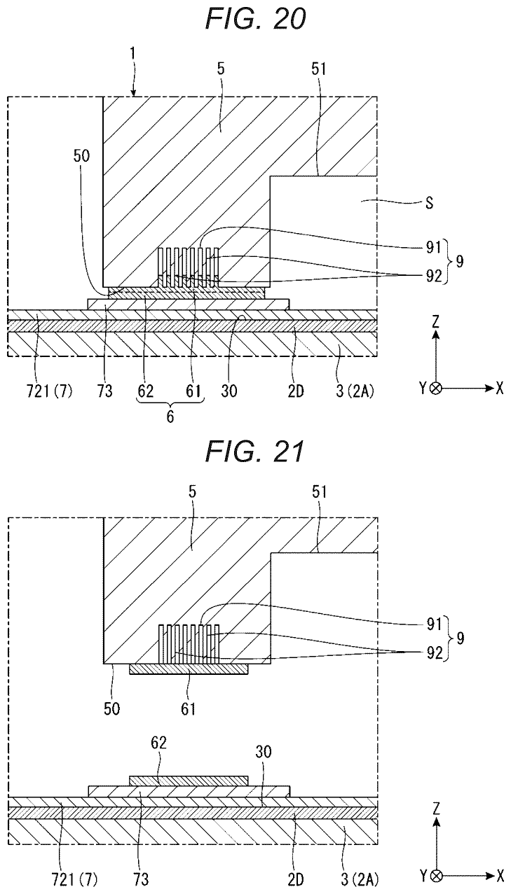

FIG. 20 is an enlarged cross-sectional view showing a bonded portion between a lid body and a base body of a physical quantity sensor according to a second embodiment. FIG. 21 is an enlarged cross-sectional view showing a state where a bonding member disposing step is completed.

The physical quantity sensor 1 according to the embodiment is similar to that in the first embodiment described above except that the configuration of the bonding member 6 is different. In the following description, differences between this embodiment and the first embodiment will be mainly described, and description of the same matters will be omitted. In the drawings of the embodiment, the same reference signs are assigned to configurations that are the same as those in the above-described embodiment.

As shown in FIG. 20, in the physical quantity sensor 1 in the embodiment, the bonding member 6 is obtained by eutectic bonding of a first metal film 61 formed at the lid body bonding surface 50 and a second metal film 62 formed at the base body bonding surface 30. Since the bonding member 6 has conductivity, in the embodiment, an insulating layer 73 is interposed between the second metal film 62 and the wirings 721, 722, and 723. In the embodiment, the first metal film 61 is made of germanium (Ge), and the second metal film 62 is made of aluminum (Al). The insulating layer 73 is made of a silicon oxide. However, the materials of the first and second metal films 61 and 62 and the insulating layer 73 are not particularly limited. Each of the first and second metal films 61 and 62 and the insulating layer 73 is formed by, for example, sputtering.

In the bonding member disposing step S3, as shown in FIG. 21, a step of forming the first metal film 61 at the lid body bonding surface 50 and a step of forming the second metal film 62 at the base body bonding surface 30 are performed, and since the pillar structure 9 formed at the lid body bonding surface 50 is a fine structure, the first metal film 61 can be formed on the pillar structure 9 without any problem.

According to the second embodiment, the same effects as those in the above-described first embodiment can still be obtained.

Although the physical quantity sensor and the method for producing the physical quantity sensor in the disclosure are described above based on the shown embodiments, the disclosure is not limited thereto, and the configuration of each part can be replaced with any configuration or step having a similar function. Any other configurations or steps may be added to the disclosure.

For example, in the above-described embodiments, the physical quantity detection element is the acceleration detection element 4 that detects the acceleration in the X-axis direction, but the physical quantity detection element is not limited thereto and may be an acceleration detection element that detects an acceleration in the Y-axis direction or an acceleration detection element that detects an acceleration in the Z-axis direction. The physical quantity detection element may be an angular velocity detection element that detects angular velocity around the X-axis, an angular velocity detection element that detects angular velocity around the Y-axis, or an angular velocity detection element that detects angular velocity around the Z-axis. The physical quantity sensor 1 may include a plurality of physical quantity detection elements having different detection targets in the accommodation space S.

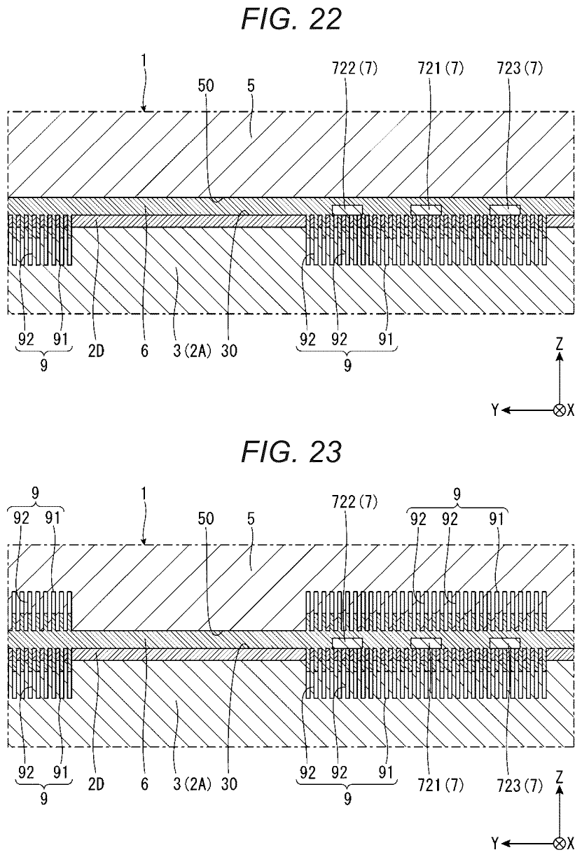

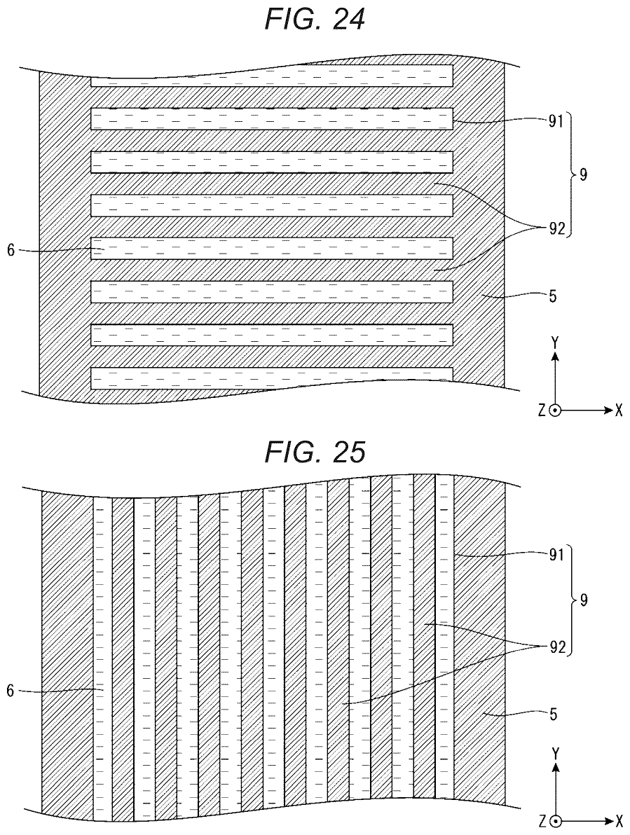

For example, as shown in FIG. 22, the pillar structure 9 may be formed at the base body bonding surface 30 instead of the lid body bonding surface 50. According to such a configuration, the same effects as those in the above-described embodiments can still be obtained. As shown in FIG. 23, the pillar structure 9 may be formed at both the base body bonding surface 30 and the lid body bonding surface 50. As shown in FIGS. 24 and 25, the pillar 92 may extend in a wall-like shape.

What is claimed is:

1. A physical quantity sensor comprising:
a base body;
a physical quantity detection element supported by the base body and configured to detect a physical quantity; and
a lid body bonded to the base body via a bonding member and configured to accommodate the physical quantity detection element between the lid body and the base body, wherein
when a surface of the base body bonded to the bonding member is defined as a base body bonding surface and a surface of the lid body bonded to the bonding member is defined as a lid body bonding surface, at least one of the base body bonding surface and the lid body bonding surface is formed with a pillar structure having a recess with a bottom and a plurality of pillar portions erected at a bottom surface of the recess and disposed at an interval from each other, and the bonding member enters the recess.

2. The physical quantity sensor according to claim 1, wherein
in a plan view of the base body,
the bonding member has a rectangular frame shape, and
the pillar structure overlaps a corner portion of the bonding member.

3. The physical quantity sensor according to claim 1, further comprising:
a wiring that is electrically coupled to the physical quantity detection element inside the lid body, passes between the base body and the lid body, and is led out to outside of the lid body, wherein
in a plan view of the base body, the pillar structure overlaps the wiring.

4. The physical quantity sensor according to claim 3, wherein
in the plan view of the base body, the pillar structure protrudes on both sides of the wiring in a direction orthogonal to an extending direction of the wiring.

5. The physical quantity sensor according to claim 1, wherein
a top surface of each of the pillar portions is flush with a surface where the recess is formed.

6. The physical quantity sensor according to claim 1, wherein
the plurality of pillar portions are regularly disposed in a matrix pattern or a checkerboard pattern.

7. The physical quantity sensor according to claim 1, wherein
a width of each of the pillar portions is 0.1 μm or more and 10 μm or less.

8. The physical quantity sensor according to claim 1, wherein
a separation distance between a pair of the pillar portions adjacent to each other is 0.1 μm or more and 10 μm or less.

9. The physical quantity sensor according to claim 1, wherein
an occupancy ratio of the pillar portions to the recess is 10% or more and 50% or less.

10. The physical quantity sensor according to claim 1, wherein
a depth of the recess is 1 μm or more and 100 μm or less.

11. The physical quantity sensor according to claim 1, further comprising:
a wiring that is electrically coupled to the physical quantity detection element inside the lid body, passes between the base body and the lid body, and is led out to outside of the lid body, wherein
in a plan view of the base body, the bonding member has a rectangular frame shape,
the pillar structure overlaps a corner portion of the bonding member, overlaps the wiring, and further protrudes on both sides in a direction orthogonal to an extending direction of the wiring,
the plurality of pillar portions regularly disposed in a matrix pattern or a checkerboard pattern,
a top surface of each of the pillar portions is flush with a surface where the recess is formed,
a width of each of the pillar portions is 0.1 μm or more and 10 μm or less,
a separation distance between a pair of the pillar portions adjacent to each other is 0.1 μm or more and 10 μm or less,
an occupancy ratio of the pillar portions to the recess is 10% or more and 50% or less, and
a depth of the recess is 1 μm or more and 100 μm or less.

12. A method for producing a physical quantity sensor including a base body supporting a physical quantity detection element that detects a physical quantity, and a lid body bonded to the base body to accommodate the physical quantity detection element between the lid body and the base body, the method comprising:
a pillar structure forming step of forming, on at least one of a base body bonding surface and a lid body bonding surface, the base body bonding surface being a surface of the base body bonded to the lid body and the lid body bonding surface being a surface of the lid body bonded to the base body, a pillar structure having a recess with a bottom and a plurality of pillar portions erected at a bottom surface of the recess and disposed at an interval from each other;
a bonding member disposing step of disposing a bonding member on at least one of the base body bonding surface and the lid body bonding surface; and
a bonding step of bonding the base body and the lid body via the bonding member.
